(19) United States
(12) Patent Application Publication
(10) Pub. No.: US 2008/0177667 A1
(43) Pub. Date: Jul. 24, 2008

(54) MOBILE COMPUTING RETAIL PLATFORM

(76) Inventor: Stephen J. Weinberg, Camas, WA (US)

Correspondence Address: MARGER JOHNSON & MCCOLLOM, P.C., 210 SW MORRISON STREET, SUITE 400, PORTLAND, OR, 97204, US

(21) Appl. No.: 11/961,793

(22) Filed: Dec. 20, 2007

Related U.S. Application Data
(60) Provisional application No. 60/880,821, filed on Jan. 18, 2007.

(51) Int. Cl. H04L 9/00; G06Q 50/00

(52) U.S. Cl. 705/64; 705/1

(57) ABSTRACT

A retail system, an access point at a venue to provide access to a network, at least one mobile platform in communication with the access point, the mobile platform having a user interface populated with a pre-programmed menu of selections, a server coupled to the access point to manage network access by the mobile platform. A method of providing a mobile retail platform includes providing a mobile computing retail platform to a user at a venue, populating a user interface on the mobile computing retail platform with a pre-programmed set of selections, providing access across a network to entities associated with the selections through a retail portal, and monitoring the access to track at least one of usage, purchases and payments. A method of managing a mobile retail system includes monitoring usage of a mobile retail platform having a pre-programmed set of selections at a venue, updating information related to the usage, and using the information to alter the set of selections as needed.

This application is a continuation of, and claims priority to, U.S. Provisional Patent Application No. 60/880,821, filed Jan. 18, 2007.

### BACKGROUND

A vast number of consumers spend large amounts of time every day waiting or idle. This may include waiting in doctors' offices, airports, restaurants, coffee shops, sporting events, concerts, disaster locations, stadiums, etc. Waiting may also occur in cars for automotive services such as oil changes, drive up teller windows, drive thru food and beverage services, etc. Some consumers read, listen to the radio, or use their cell phones while waiting.

With the advent of ‘smart phones’ people may even browse the Internet, including shopping on-line. However, the screens for these phones are small, and they require the use of the cellular phone providers to access the Internet or other networks that may have slower connection speeds than would be desirable. Using a smart phone, the user either has to search for the retailer they want or know the site to which that user wants to go. In addition, payment can be difficult because of security concerns of entering payment information.

The retailer or location at which the person is waiting is missing a powerful and unique marketing opportunity for the captive audience made up of waiting users. A particular retailer or venue will have general information on the demographics of their particular visitors and could use that data to present attractive choices to the waiting consumers that would maximize the probability of sales. For example, a sports bar that has a high percentage of customers that follow a particular sport, such as NASCAR®, is missing an opportunity to allow the customers to purchase NASCAR® gear.

### BRIEF DESCRIPTION OF THE DRAWINGS

FIG. 1 shows an embodiment of a retail system.

FIG. 2 shows a flowchart of a method of providing a mobile retail platform for consumers.

FIG. 3 shows a flowchart of a method of managing a mobile retail system.

FIGS. 4-7 show embodiments of a user interface.

FIGS. 8 and 9 show alternative views of an embodiment of a cradle for a mobile retail system.

### DETAILED DESCRIPTION OF THE EMBODIMENTS

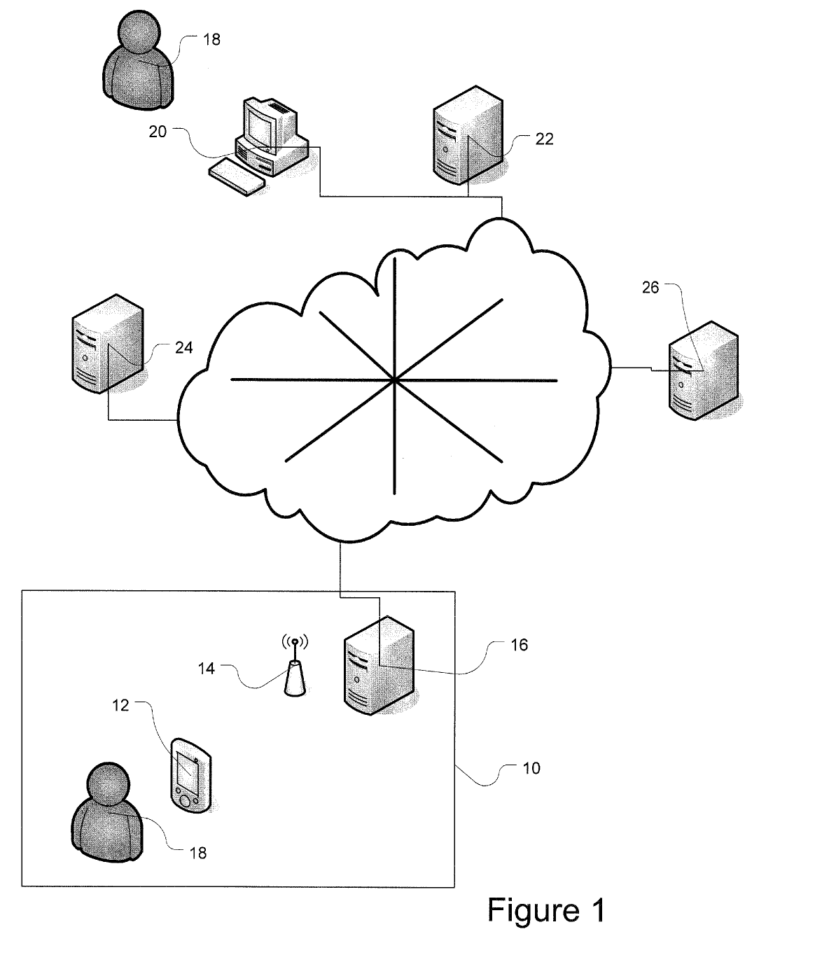

FIG. 1 shows a network retail system using a mobile retail platform. As used here, a mobile retail platform means any device that can be used at a particular venue to allow users to access retailers, information, entertainment and other services while at that venue. “Mobile” does not necessarily mean that the device itself is mobile, but that the retail/content access is mobile. In some embodiments, using mobile electronic devices or kiosks with a wireless capability, the access may be wireless. In other embodiments, using hard-wired kiosk into a ‘wired’ network, the access would not be wireless. As will be discussed in more detail later, the user may also use the mobile retail platform to set up one or more accounts while at the venue and access the account or accounts later from other venues.

As they are waiting or idle, consumers would be given some sort of computing device, such as a laptop, notebook computer, tablet computer, personal digital assistant, Blackberry™, smart phone, iPod®, or even just access to a fixed or detachable computer kiosk. The main characteristics of the device is that it is located at the venue where the consumers are waiting, it has a connection, either wired or wireless to an access point that allows access to a network such as the Internet, and is capable of displaying a user interface that presents a pre-programmed set of selections for the user to access while waiting.

In FIG. 1, the user 18 is waiting or otherwise idle at the venue 10. The venue could be any place where people congregate, including doctors' offices, auto service providers, such as repair and quick lube shops, banks, ticket lines, airports, train stations, sport or concert stadiums, etc., as well as places where they may not necessarily be waiting for something but may be eating, having coffee, etc. The user 18 may also be in a vehicle.

The user would be ‘given’ a computing device 12. The term ‘given’ as used here means loaned, given access to, or rented, as examples. For example, at a quick lube place, the user could be handed a small, portable, ruggedized, tablet computer while sitting in the vehicle to be serviced, and the user could use the computer to access a pre-programmed menu while waiting. Alternatively, the user could just gain access to a computer kiosk located in a waiting room.

Generally, the user could also use his or her own computer or other communication-capable electronic device while at the venue. However, the system at the venue would restrict the device's access to only the pre-programmed menu. The user's device would be restricted from going freely to any Internet site.

In addition, once the user account is set up, the user could receive a code or other token after accessing the user interface and setting up an account. The user 18 could then return to his or her home or office and use a desktop or other computer such as 20 to access the retail system's web site and that user's saved shopping cart, order history, etc. The user could also create a new account or use an existing account on retail sites.

The device 12 may include a payment system. The payment system could be a card reader such as 11, either ‘swipable’ or a card scanner, or could be a user interface to a secure transaction system to allow entry of the user's payment information using a keypad, stylus or a mouse.

Returning to the venue 10, the user would access one or more of the pre-programmed selections of the user interface presented on the device. The user could shop retail web sites in the menu, get information, read the news, play games, pay for a movie or TV show to watch on the device, etc. The selections and any associated information, such as a music video, television show, web site for shopping, etc., will be referred to here as content, and the vendors that provide the content will be referred to as content providers.

As the user makes selections on the device 12, it is relayed through the access point 14 to the server 16 that provides network access, monitors the usages of the devices at the venue, etc. The monitoring of the usage may include generating information on customer preferences, demographics, the customer's ‘click stream’ of information, etc. A ‘click stream’ is the series of selection clicks made through an interface device, such as a mouse or stylus, that tracks the sites accessed, either through other sites or directly. It is the recording of what a computer user clicks on while web browsing or using a personal computer. As the user clicks anywhere in the tool, application or the webpage the action is logged on a client or inside the web server, as well as possibly the web browser, routers, proxy servers, and ad servers. The user click stream and information about purchases made, etc., will be referred to here as usage history.

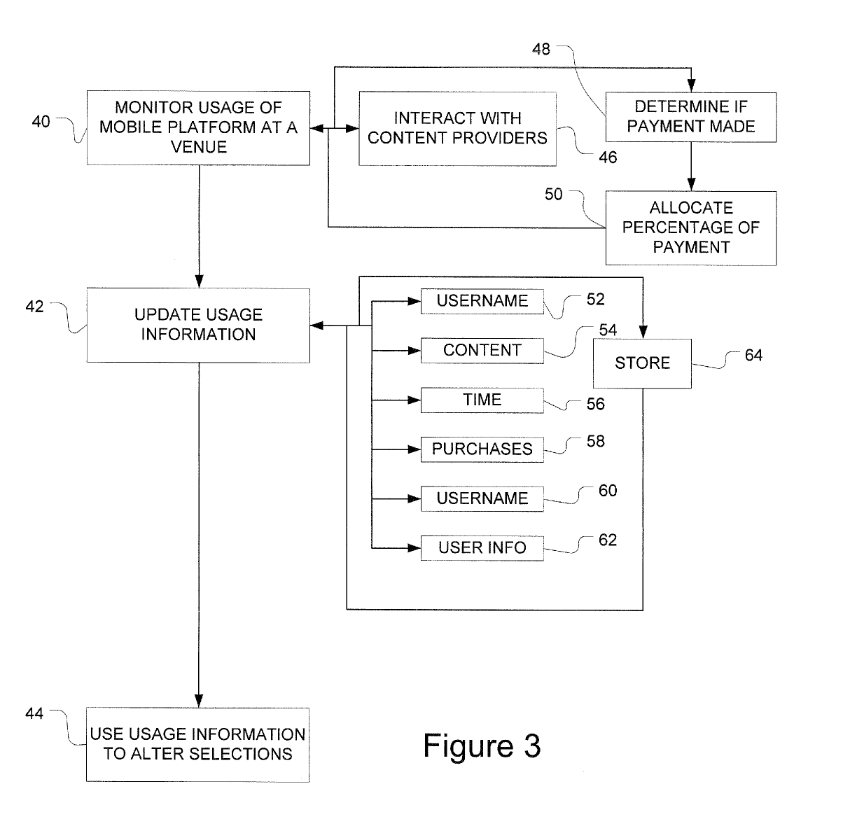

In one embodiment, the access point and the server would be contained in a single device. As will be discussed in more detail later with reference to FIG. 3, there may be several other servers, either separate from the access point or separate from the access server 16, or any combination of servers and the access point. These servers may include a secure transaction server such as 24 to govern user's payment information and to effect payments, an accounting server such as 26 to track the various allocations between retailers, the venue and the retail system, and a demographics server 26 to track user information and usage for better targeting of selections at various venues. Any or all of these servers may include a repository to securely store the information for later analysis, tracking and future selection determination for altering the programmed menus.

Having seen an overview of the system, the discussion can move on to the various aspects of the system associated with the venue owner/retailer, the content providers and the users as they interact with the overall system. It should be noted that the retail system itself may be provided by another party, referred to here as the system retailer, or the retail system may be provided by the venue owner, or by the content providers. In the case of a retail system provider, for example “Main Street PC USA, Inc.” the servers mentioned above would more than likely be owned and managed by the retail system provider. This may also facilitate the user being able to access their retail system account from any location, as mentioned above.

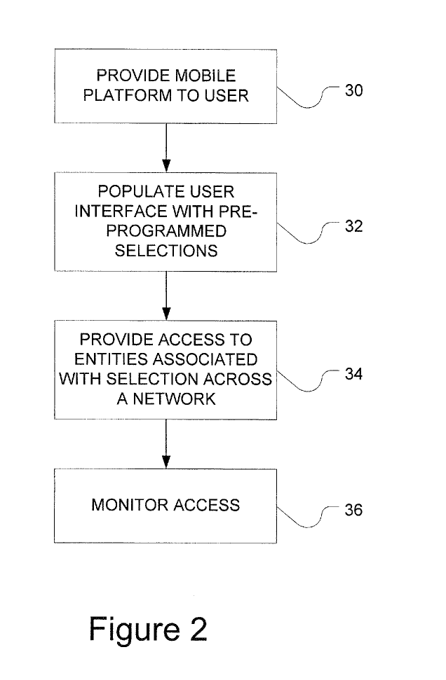

FIG. 2 shows a flowchart of a method to provide the mobile retail platforms at a venue. At 30, the venue owner or service provider provides a mobile platform to the user. The venue owner may not be the owner of the mobile platforms themselves, but may just contract to have a third party that comes in and runs the mobile retail platform system within its premises.

As mentioned above, the provision of the mobile platform may be on a leased, rented, loaned, etc., basis. The venue owner may have a vending system for dispensing the platforms, such as is used in airplanes with telephones. For example, a user would insert a credit/debit card to release the platform and if the user walks off with the device, the credit card would be charged for the device. The credit/debit card would provide collateral. Alternatively, the system may be provided as a kiosk or computer station fixed in a location at the venue. The vending system, however embodied, would include a user interface and a payment system and have some security to ensure retention of the platform at the venue.

The venue provider, either through the third party retail system vendor, or through its own resources, provides the device with a user interface having a pre-programmed set of selections at 32. This is one of many aspects of the retail system that differs from a user using a smart phone or laptop within a networked ‘open’ environment. In those instances, the user can browse or access any parts of the web the user desires. In this instance, the user can only access those selections or locations that the venue provider wants the user to access.

This may have advantages for the user as well. Some of the content providers may only allow access to their content for paid subscribers when accessed in a public manner over a network. In some instances, the content provider may waive the fee, or work out an enterprise wide fee for the venue owner to allow user's at that venue to access otherwise pay-per-access services for free. In addition, the user can quickly find favorites, rather than searching for sites of interest.

As the user views and makes selections on the platform, the venue owner will have an access point, server, or combination that allows access to the various entities across a network at 34. Entities represented may include dedicated retailers, where the user access the retailer's goods only; general purpose retailers where the user can buy several different types/brands of goods at one site, such as Amazon.com®; news and information providers, games, videos, music, etc., either on a pay-per-use basis or for free; and venue-specific entities, such as the ability to add gift cards, services or other items to the bill that will be paid before the user exits the premises.

The ability to add items to the bill for the venue-specific entities would be in the circumstance where the user is adding additional services or goods to the bill for whatever it is they are waiting. The user could be at a sports bar and decide to buy gift cards for that person's friends. The costs of those gift cards could be added to the bill and paid for when the user exits the bar. In addition, the user could pay for those gift cards as a separate transaction using the card swiper on the mobile device, or the user could put those transactions on hold in a saved shopping cart. The user may also be able to print out coupons of on site, nearby or demographic-specific retailers.

As the user accesses the sites and makes purchases, payments or other transactions, the venue owner or the venue owner's retail system provider will monitor the interactions at 36 and record significant events, such as sites accessed, the user's click-stream, the user's specifics (address, name, payment method), the time of day, etc. All of this information would then be used by the venue provider to analyze the provided content and the demographics of the users to allow for better target marketing both at the venue and in the overall system. “Better” target marketing would be that marketing that increases revenues, more clicks/usage per user and in general higher usage level of the system over time.

An embodiment of a flowchart of this process from the retail system and content provider's perspective is shown in FIG. 3. At 40, the retail system monitors the usage of mobile platforms at all of the venues at which the system is deployed. In addition, the retail system provider interacts with the content providers at 46 to access content, make agreements as to new content provided, etc. When a payment is made at 48, the payment may be allocated between the retail system provider, the venue owner and the content providers according to whatever agreements are in place at 50. Payments may be made at the device, either by secure transaction screens or a card reader, on the user's home or office computer, or through a kiosk.

In addition to payments being allocated, there could be payments made based upon usage. For example, the venue provider may receive advertising fees from content providers and retailers for including that entity on the menu, or from banner advertisements, etc.

As the system gathers usage information from all of the users at all of the sites where the system is deployed the system updates this information at 42. In addition, the information about the typical user of the system may be profiled as well as the user's information gathered to establish an account for the user. This information may be made available as publishable reports with graphs automatically from the system. As is typical in many online retailers, the user could establish an account using the user's e-mail account as the user name. For the circumstances when the user is in a car, the vehicle license plate number could be used as well. Examples of the types of information that the system may gather is shown at 52-62. At 64, this information may be stored, either at the venue owner's premises, by the online retailer to whom the user had access, or at a centralized repository run by the retail system.

At 44, as mentioned above, at any time, the retail system may make changes to the pre-programmed selections that the user views and accesses. These changes may be on a venue basis, a platform basis, a content basis, or a system-wide basis depending upon the analysis done by the retail system. For example, the system may determine that no one at an oil change place in California accesses a travel web site specializing in travel to Arizona. The change would be made for that venue or venues. Additionally, the system may determine that no one wants to play a particular video game, so that game may be removed from the selections for content. Further, there may be a retailer who is no longer in business, or that no one accesses and that retailer may be removed locally or system wide.

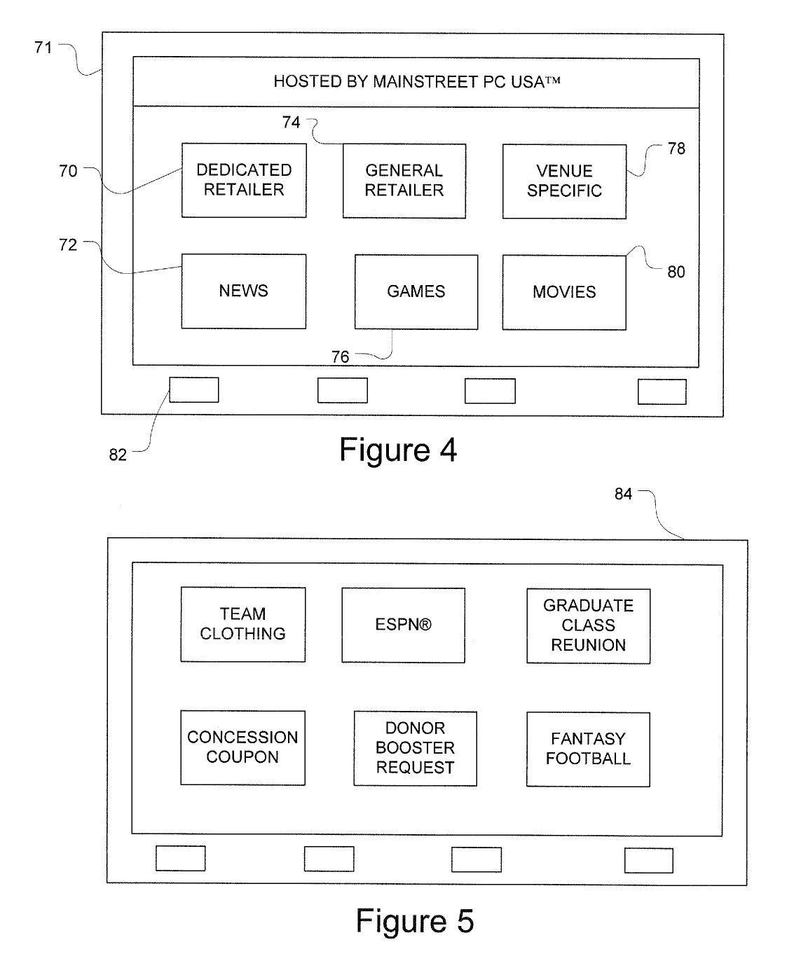

All of these decisions, as well as any local decisions made at the venue site, affect the selections provided on the user interface, either on the venue-provided mobile device, the user's device or the kiosk, to the user. FIG. 4 shows an example of a user interface used on the mobile retail platform. As can be seen, the user interface consists of a set of pre-programmed ‘soft’ buttons 70-80. In addition, the platform may have ‘hard’ buttons on the casing such as 82 that allows the user to perform other functions, such as ‘Back,’ ‘Forward,’ ‘Menu,’ ‘Stop,’ ‘Exit,’ etc. The contracted, third party provider of the system may also have the opportunity to identify itself as the provider in banner 71.

As shown in the examples of soft buttons 70-80, each soft button provides access to a different provider, such as a dedicated retailer 70, a general retailer 72, a venue specific selection 78, a news selection 72, a games selection 74 and a movies selection 80. These are all switchable and adjustable, either by the venue owner or the retail system provider, and may be swapped out for something else. In one embodiment, the soft buttons may be ‘intelligent’ buttons and may actually transform themselves based upon time or day or user entered demographic, interest data and inputs made over time.

FIGS. 5-7 show examples of different pre-programmed menus that are set up in a venue-specific maimer. FIG. 5 shows an embodiment of a menu 84 that may be made available to spectators at a college football stadium venue. The menu provides soft buttons for team clothing for one or both teams playing that day, a link to ESPN®, a link to a graduate class reunion page, a coupon for concessions, a path to make a donation to the booster club for that team, and a link to a fantasy football league web site.

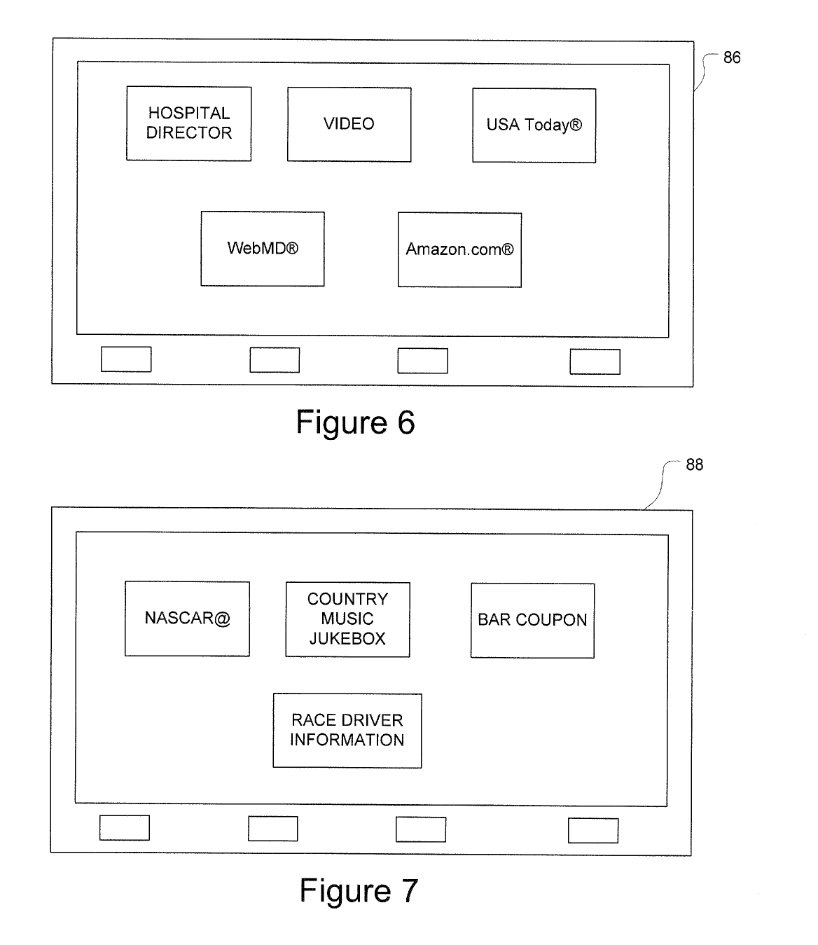

FIG. 6 shows a menu 86 for a doctor or other health provider office. For the purposes of this discussion, the office may be located adjacent to or in a hospital. The links provided on the pre-programmed menu include access to a hospital directory, a link to the WebMD® web site, the ability to watch a video, read USA Today®, or shop at Amazon.com®.

FIG. 7 shows a menu 88 for a sports bar that is frequented by NASCAR® race fans. The menu would offer opportunities to buy NASCAR® gear, the ability to listen to country music from a ‘juke box’ interface, find information on the NASCAR® drivers, or access a coupon for a drink special at the bar.

Similar to the concessions coupon for the football stadium, the drink special coupon may be have a code/password that must be given to the server at either the bar or stadium concessions to allow the user to use the coupon. Alternatively, the coupon could be associated with the user's name and printed at the bar or concession stand. The user would then ask the server to check for the coupon when the user wants to take advantage of it. In a wireless retail environment, where the servers use personal digital assistant (PDA) type devices to take orders, the coupon could even be ‘beamed’ or sent to the server's PDA, or sent to the billing system prior to the processing of that user's check.

The selection of coupons for the current venue, as well as advertising, service history, gift card purchase, etc. will be referred to here as venue-specific menu selections or selections linked to the venue.

In addition, these menus may be the ‘bottom’ menu in a series of menus. There may be several layers of menus possible. For example, a top menu may provide a listing of options, such as ‘shopping,’ ‘news,’ ‘entertainment,’ ‘local coupons’ offering coupons at other shops in the same strip mall, ‘venue specific information’ such as car service history and services due for a quick lube venue, etc. Each menu would be drillable into more specific menus or menu for each option.

The user interface may be embodied on any type of device, as mentioned in detail above. For the user that is in a vehicle, it may be possible to also provide a cradle or holder that can loop over the vehicle's steering wheel to allow more convenient access and use of the device. FIGS. 5 and 6 show a front and back view of such a holder.

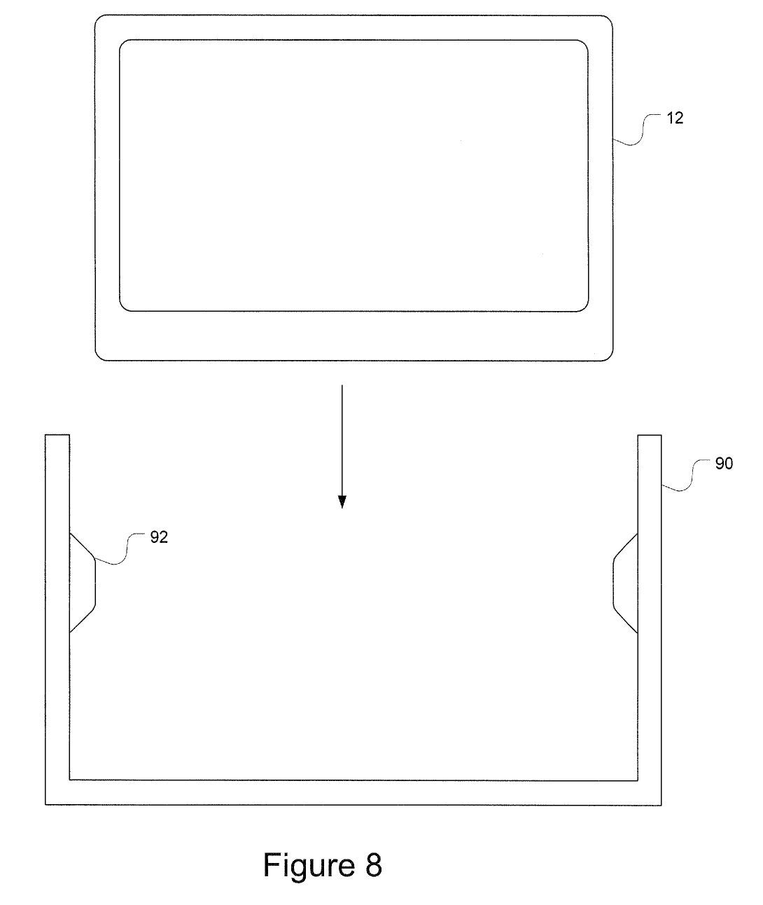

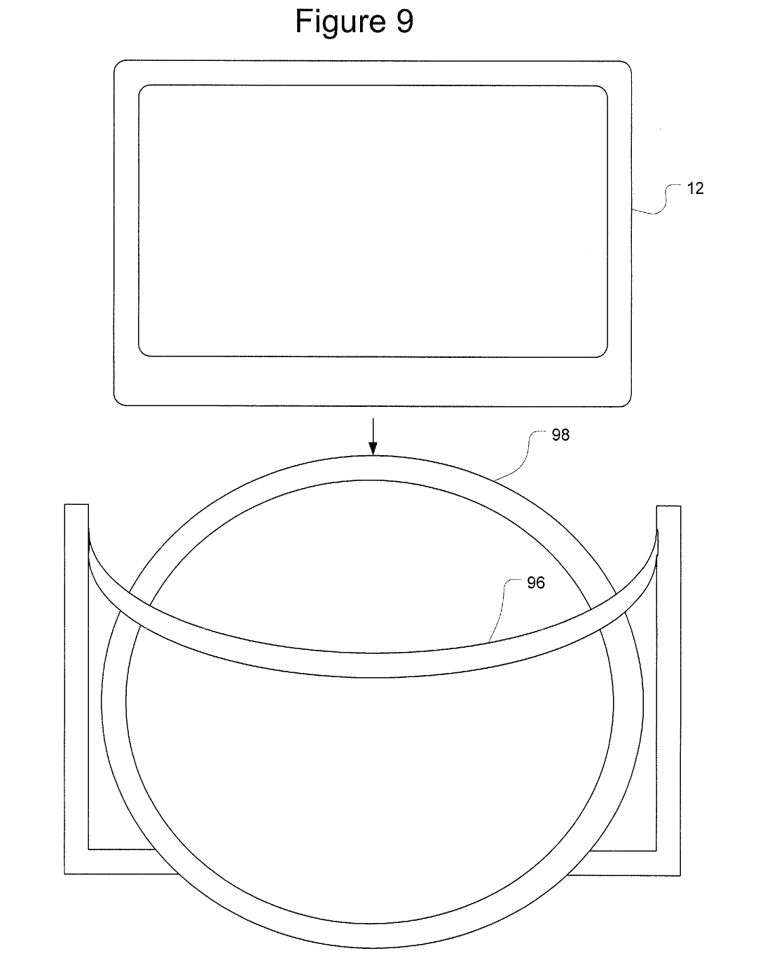

FIG. 8 shows a front view of a cradle 90 into which a mobile retail platform 12 may be inserted. The cradle may include clips or covers such as 92 to hold the device safely in place during vehicle movement in the line. It may also include protective pads, padding, etc. to prevent scratching of the vehicle's equipment and the device. FIG. 9 shows a rear view of the cradle with a strap that can go over the vehicle steering wheel to hold the platform in a convenient position. This view would be looking out at the steering wheel from the dashboard perspective.

One aspect of the system is the wireless transmission of personal information about the users including their names, addresses, payment information, etc., within the venue. For the mobile devices that are linked to the access point wirelessly, the information from the access point onwards to the network would more than likely be secured by network security features. The information traveling across the multiple wireless links in a wireless venue setting may be vulnerable to attack. Sufficient wireless security would be provided to prevent capture or usurping of this information in any ‘hackable’ form. Options include tokens, encryption, digital signatures, erasable flash memory, etc. In addition, devices could use flash memory rather than hard drives and all information would be electronically erased when the user is finished.

In this manner, the user is provided with a pre-programmed set of selections that are targeted to the venue and its customers' demographics. This provides venue owners and retailers a previously-untapped opportunity to provide information, entertainment and generate revenues from otherwise unreachable or unavailable consumers.

Thus, although there has been described to this point a particular embodiment for a method and apparatus for mobile retail platforms and tracking their usage, it is not intended that such specific references be considered as limitations upon the scope of this invention except in-so-far as set forth in the following claims.

What is claimed is:

1. A retail system, comprising:
an access point at a venue to provide access to a network;
at least one mobile platform in communication with the access point, the mobile platform having a user interface populated with a pre-programmed menu of selections; and
a server coupled to the access point to manage network access by the mobile platform.

2. The retail system of claim 1, wherein the access point and the server are co-located.

3. The retail system of claim 1, wherein the server is remote from the access point.

4. The retail system of claim 1, wherein the mobile platform further comprises one of a computing device made available at the venue only for use at that venue, or a user-owned device with restricted access.

5. The retail system of claim 4, wherein the computing device further comprises one of a laptop, notebook computer, tablet computer, personal digital assistant, personal computer, or a dedicated computing device.

6. The retail system of claim 4, wherein the venue includes a vending system for the mobile platforms including a payment system.

7. The retail system of claim 1, the system further comprising a secure transaction server, an accounting server, a subscription server, a demographics server and a repository.

8. A method of providing a mobile retail platform, comprising:
providing a mobile computing retail platform to a user at a venue;
populating a user interface on the mobile computing retail platform with a pre-programmed set of selections;
providing access across a network to entities associated with the selections through a retail portal; and
monitoring the access to track at least one of usage, purchases and payments.

9. The method of claim 8, wherein providing a mobile computing retail platform further comprises providing one of a laptop, notebook computer, tablet computer, personal digital assistant, or personal computer.

10. The method of claim 8, wherein providing a mobile computing retail platform includes providing a mobile computing retail platform having a payment system.

11. The method of claim 8, wherein populating a user interface further comprises providing soft buttons for at least one of a dedicated retailer, a general retailer, a news provider, a games provider, or a selection linked to the venue.

12. The method of claim 8, further comprising recording and storing information about the access associated with the user and the venue separately from the platform.

13. The method of claim 12, further comprising determining a target demographic from the information about the access and populating the user interface based upon the target demographic.

14. The method of claim 13, wherein populating the user interface further comprises populating the user interface based upon purchases, usage and interests of the target demographic.

15. The method of claim 12, wherein providing a mobile computing retail platform further comprises securing retention of the platform at the venue.

16. The method of claim 8, further comprising allowing a user to establish an account through the mobile retail platform for later access, the access not being limited to the platform.

17. The method of claim 16, further comprising saving information regarding the usage by the user and associating the information with the account.

18. A method of managing a mobile retail system, comprising:
monitoring usage of a mobile retail platform having a pre-programmed set of selections at a venue;
updating information related to the usage; and
using the information to alter the set of selections as needed.

19. The method of claim 18 further comprising interacting with content providers to populate the pre-programmed set of selections.

20. The method of claim 18, wherein monitoring the usage further comprises:
determining if a payment has been made to a content provider; and
allocating percentages of the payment to the content provider and the venue.

21. The method of claim 18, wherein monitoring the usage further comprises tracking usage and determining a fee for the venue provider based upon the usage.

22. The method of claim 18, wherein updating the information related to the usage further comprises updating at least one of a user name, content accessed, time of day, venue, purchases made, and user information.
